(19) United States
(12) Patent Application Publication
(10) Pub. No.: US 2025/0388201 A1
(43) Pub. Date: Dec. 25, 2025

(54) INTEGRATED BRAKING INTERFACE DEVICE

(71) Applicant: Infineon Technologies AG, Neubiberg (DE)

(72) Inventors: Benno KÖPPL, Markt Indersdorf (DE); Cristian MURTAZA, Bucharest (RO)

(21) Appl. No.: 18/747,911

(22) Filed: Jun. 19, 2024

(51) Int. Cl. B60T 13/74; B60T 8/171; B60T 8/88

(52) U.S. Cl. CPC B60T 13/741; B60T 8/171; B60T 8/885

(57) ABSTRACT

An integrated braking interface device is described. The integrated braking interface device includes driver circuitry housed within a package to drive switches of a bridge circuit to control a braking mechanism of a vehicle. The integrated braking interface device includes at least one braking system interface circuit housed with the driver circuitry within the package. The at least one braking system interface circuit includes one or more of a wheel speed sensor interface (WSSI) to receive wheel speed data from at least one wheel speed sensor of the vehicle and a parking lock interface (PLI) to control an actuator to lock at least one wheel of the vehicle.

### TECHNICAL FIELD OF THE INVENTION

This invention relates generally to automotive vehicle systems, and more specifically to braking systems for use in automotive vehicles.

### BACKGROUND

In a typical electromechanical braking system used in modern vehicles, microcontrollers are coupled to communicate with other discrete, separately packaged braking system components to implement functionality of the braking system, for example to receive sensor input and/or to control braking system components. As an important system in modern vehicles, a need exists for improvements in vehicle braking systems.

### SUMMARY

This disclosure is directed to improvements in vehicle braking systems. According to one example, an integrated device includes a package, driver circuitry housed within the package to drive switches of a bridge circuit to control a braking mechanism of a vehicle, and at least one braking system interface circuit is housed with the driver circuitry within the package. The at least one braking system interface circuit includes one or more of a wheel speed sensor interface (WSSI) to receive wheel speed data from at least one wheel speed sensor of the vehicle and a parking lock interface (PLI) to control an actuator to lock at least one wheel the vehicle.

According to another example, a method is described. The method includes arranging driver circuitry configured to drive switches of a bridge circuit to control a braking mechanism of a vehicle within a package. The method further includes arranging at least one braking system interface circuit with the driver circuitry within the package including one or more of a wheel speed sensor interface (WSSI) to receive wheel speed data from at least one wheel speed sensor of the vehicle and a parking lock interface (PLI) to control a solenoid to lock at least one wheel of the vehicle.

According to another example, a braking system is described that includes a main controller housed in a first package and driver circuitry housed in a second package. The main controller is configured to control the driver circuitry to drive switches of a bridge circuit to control a braking mechanism of a vehicle. At least one braking system interface circuit is housed with the driver circuitry within the second package. The at least one braking system interface circuit includes one or more of a wheel speed sensor interface (WSSI) to receive wheel speed data from at least one wheel speed sensor of the vehicle and output the wheel speed data to the main controller, and a parking lock interface (PLI) configured to be controlled by the main controller to control an actuator to lock at least one wheel of the vehicle.

### BRIEF DESCRIPTION OF THE DRAWINGS

FIG. 1 is a block diagram depicting components of a vehicle braking system that includes an integrated braking interface device according to some embodiments.

FIG. 2 is a block diagram that depicts one example of a driver circuitry that may be integrated as part of integrated braking interface device according to some embodiments.

FIG. 3 depicts a wheel speed sensor interface (WSSI) which may be integrated in a package with driver circuitry according to some embodiments.

FIG. 4 depicts a parking lock interface (PLI) which may be integrated in a package with driver circuitry according to some embodiments.

FIG. 5 is a block diagram depicting one example of a serial peripheral (SPI) interface which may be housed within a package of an integrated braking interface device according to some embodiments.

FIG. 6 is a block diagram that depicts an integrated braking interface device that includes driver circuitry housed within a package along with one or more braking system interface circuits according to some embodiments.

FIG. 7 is a block diagram that depicts an integrated braking interface device configured to serve as an interface for more than one wheel of a vehicle according to some embodiments.

FIG. 8 is a flow diagram that depicts a method of forming an integrated braking interface device according to some embodiments.

### DETAILED DESCRIPTION

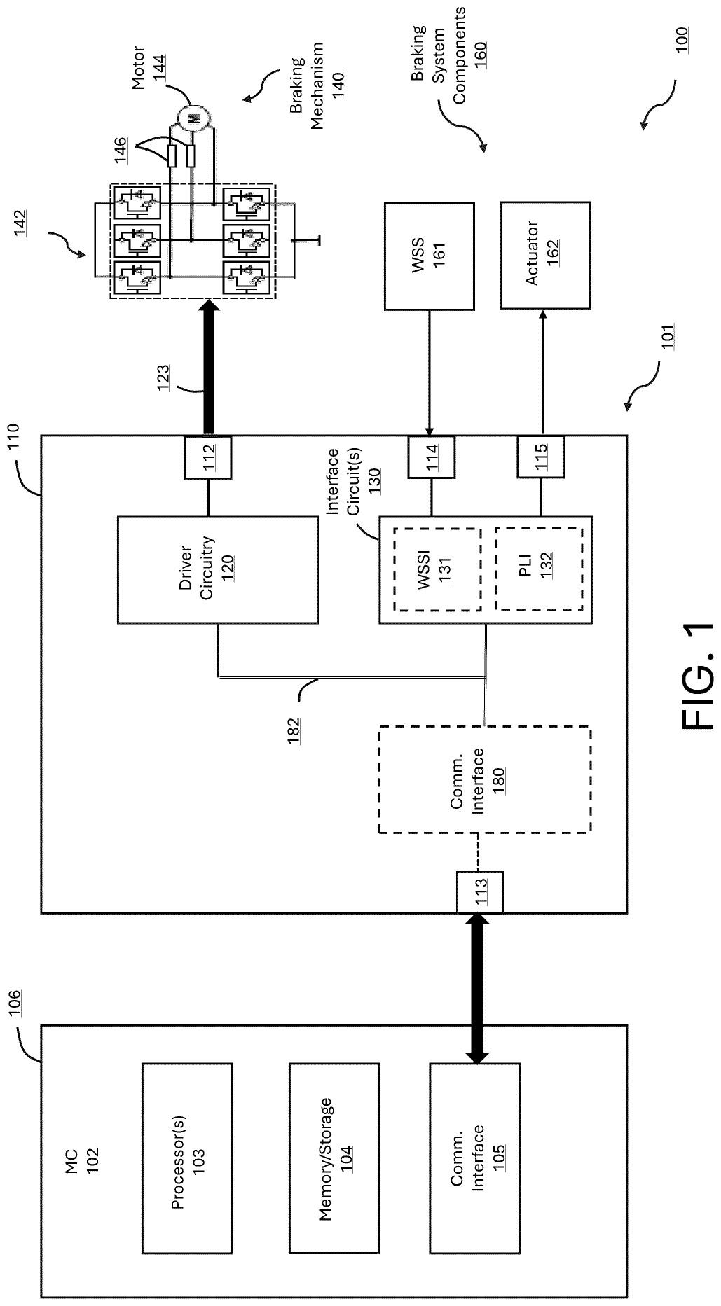

FIG. 1 is a block diagram depicting components of a vehicle braking system 100 that includes an integrated braking interface device 101 (hereinafter “integrated device 101”) according to some embodiments. The integrated device 101 is uniquely configured to serve as an interface for multiple components of vehicle braking system 100. The integrated device 101 includes driver circuitry 120 housed within package 110, which is used to control a braking mechanism 140 of a vehicle. In addition, integrated device 101 includes one or more other braking system interface circuits 130 housed within the same semiconductor package 110, including one or more of a wheel speed sensor interface (WSSI) 131 and a parking lock interface (PLI) 132 housed within the same package 110.

The package 110 may be any type of packaging component with an insulative housing configured to protect the drive circuitry 120, the WSSI 131, and/or the PLI 132, as well as other components of integrated device 101 and present I/O ports on the package 110 to couple to circuits housed within the package 110 from external to the package 110. For example, the package may be a flip-chip type package, a wire-bond type package, or any other type of package. As non-limiting examples, the package 110 may include a quad-flatpack-no-lead (QFN) package, a very-thin-quad-flatpack-no-lead (VQFN) package, or other type of package with similar characteristics.

The driver circuitry 120 is housed within the package 110 and configured to be coupled through one or more I/O ports(s) 112 of the package 110 to control a bridge circuit 142 of the braking mechanism 140. The bridge circuit 142 is coupled to control a motor 144 configured to compress or release a brake pad against a brake wheel or drum of a vehicle wheel to control the rotational movement of the wheel to slow or stop the vehicle.

As shown in the example of FIG. 1, the bridge circuit 142 may include a plurality of high and low side power transistor pairs, with each pair coupled to deliver energy to drive a respective phase of a motor 144. The motor 144 may be a three-phase motor as shown in the FIG. 1 example but may instead include more or fewer phases. The motor 144 may be, for example, a brushless direct current (DC) motor, a brushed DC motor, or any type of motor suitable to control the braking mechanism 140. The bridge circuit 142 may include, as a non-limiting example, six Metal Oxide Semiconductor Field Effect (MOSFET) power switches specifically configured to be turn on and off with a defined duty cycle to transfer energy to a load. The driver circuitry 120 is coupled through the I/O port(s) 112 to drive gate terminals of the power switches of the bridge circuit 142. For example, the driver circuitry 120 may receive control signals from external to the package 110, and amplify the control signals as a gate drive signal with a current sufficient to turn on and off the power switches of the bridge circuit 142 with a defined duty to transfer energy to the respective phases of the motor 144. In some examples, the driver circuitry 120 receives the control signals from a main controller 102.

As shown in FIG. 1, in addition to the driver circuitry 120, other braking system interface circuit(s) 130 are also housed in the package 110 with the driver circuitry 120. The braking system interface circuit(s) 130 include at least one of a wheel speed sensor interface (WSSI) 131 and/or a parking lock interface (PLI) 132 integrated in the package 110 with the driver circuitry 120. The WSSI is coupled through one or more I/O ports 114 to receive wheel speed data 163 from a wheel speed sensor 161 to measure an angular speed of a wheel of the vehicle. The PLI 132 is coupled through one or more I/O ports 115 of the package 110 to control an actuator 162 to lock a wheel, to implement a parking lock function of the vehicle. In some examples, the PLI 132 the actuator 162 is a solenoid, and the PLI 132 is configured to control the solenoid to lock or release a vehicle wheel. In other examples, the actuator 162 is an additional motor configured to lock the braking mechanism 140 of the vehicle. In still other examples, the actuator 162 may include any mechanical, hydraulic, electronic, or other mechanism configured to lock the wheel and inhibit it from rotating.

Main controller 102 may be a microcontroller that includes one or more processors 103 (e.g., a microprocessor, digital signal processor (DSP), reduced instruction set (RISC) processor, etc.) housed within a package 106 that are configured to control functions of braking system 100 and/or other systems of a vehicle. The processor(s) 103 of the main controller 102 are configured to execute instructions stored in a memory/data storage component 104 to implement braking system 100 and/or other vehicle features or functions. As also shown in FIG. 1, main controller 102 includes a communications interface 105 configured to communicatively couple main controller 102 to external components.

In the example of FIG. 1, the integrated device 101 includes a communications interface 180 mounted within the package 110, which is coupled to the main controller 102 via one or more I/O ports 113 of the package 110. The communications interface 180, (and the communications interface 105) may be configured to communicate using synchronous serial communications using a main and sub architecture (also known as a master-slave architecture) in which data bits are communicated synchronized with a system clock of the main controller 102. One example of a such a synchronous serial communications protocol is a serial peripheral interface (SPI) protocol. In other examples, communications interface 180 may be configured to communication using an I2C communications protocol. In still other examples, the communications interface 180 may utilize Controller Area Network (CAN), Local Area Network (LIN), Ethernet, or any other communications protocol suitable for enabling main controller 102 and integrated device 101 to communicate with one another. The integrated device 101 further includes a communication bus 182 also housed within the package 110 that communicatively couples the driver circuitry 120 the WSSI 131 and/or the PLI 132 to communicate with the main controller 102 using the communications interface 180.

According to the example of FIG. 1, main controller 102 is configured to use the integrated device 101 as an interface to control multiple distinct components of braking system 100. The main controller 102 executes instructions to send control signals 123 (with a defined duty cycle to turn on and off power switches of the bridge circuit 142) through the communications interface 180 to supply energy to the motor 144 to compress or release the brake pad consistent with the position of a brake lever and/or based on other data or user input. The main controller 102 also executes instructions to send other control signals through the communications interface 180 to the integrated device 101, for example to control an actuator 162 to lock or release a wheel. The main controller 102 also receives data through the communications interface 180 used to control braking system 100, for example wheel speed data from a wheel speed sensor 161 associated with a wheel of the vehicle, or other sensor data. Although not depicted in FIG. 1, in some examples, system 100 may include a power management integrated circuit (PMIC) configured to supply power to the main controller 102. In some examples, such a PMIC may be implemented in a discrete package and coupled to the main controller 102. In other examples, such a PMIC may be housed in package 106 with the main controller 102.

A traditional vehicle braking system includes a microcontroller that is coupled to each of the various components of a vehicle braking system by distinct interface components. For example, a traditional braking system may include a microcontroller housed in a first distinct package mounted on a system printed circuit board (PCB) with at least one separate gate driver device housed in a second package to drive a motor of the braking system, a separate wheel speed sensor interface housed in a third distinct package to receive wheel speed data, and a separate parking lock interface housed in a fourth distinct package configured to control a solenoid to lock one or more vehicle wheels to implement a parking lock. According to such a traditional braking system, each respective discrete component incorporates a communication interface to communicate with external components, such as the microcontroller.

System 100 depicted in FIG. 1 may offer significant advantages in comparison to traditional vehicle braking systems implemented using discrete components as described above. By using integrated braking device 101, system 100 can be implemented with reduced complexity and/or cost, because fewer components need be separately mounted and interconnected. In addition, the integrated device 101 may enable simpler and/or shorter electrical connections between the main controller 102 and the braking system interface circuits 130 of system 100, which may reduce noise introduced to system 100 and thereby increase efficiency and/or performance of system 100 and/or enable system 100 to be implemented with reduced cost. In addition, as shown in FIG. 1, a communication interface 180 of integrated device 101 may be used by the multiple components of integrated device 101 to communicate with the main controller 102, which may reduce an overall complexity and/or footprint to implement system 100 in comparison traditional vehicle braking systems. In addition, system 100 may implemented using a reduced number of main controller 102 I/O ports, thereby freeing I/O ports of main controller 102 to be used to support other vehicle features or functions. In addition, integrated device 101 may enable system 100 to be flexibly implemented with different main controllers 102 (e.g., microcontrollers from different manufacturers or with different features).

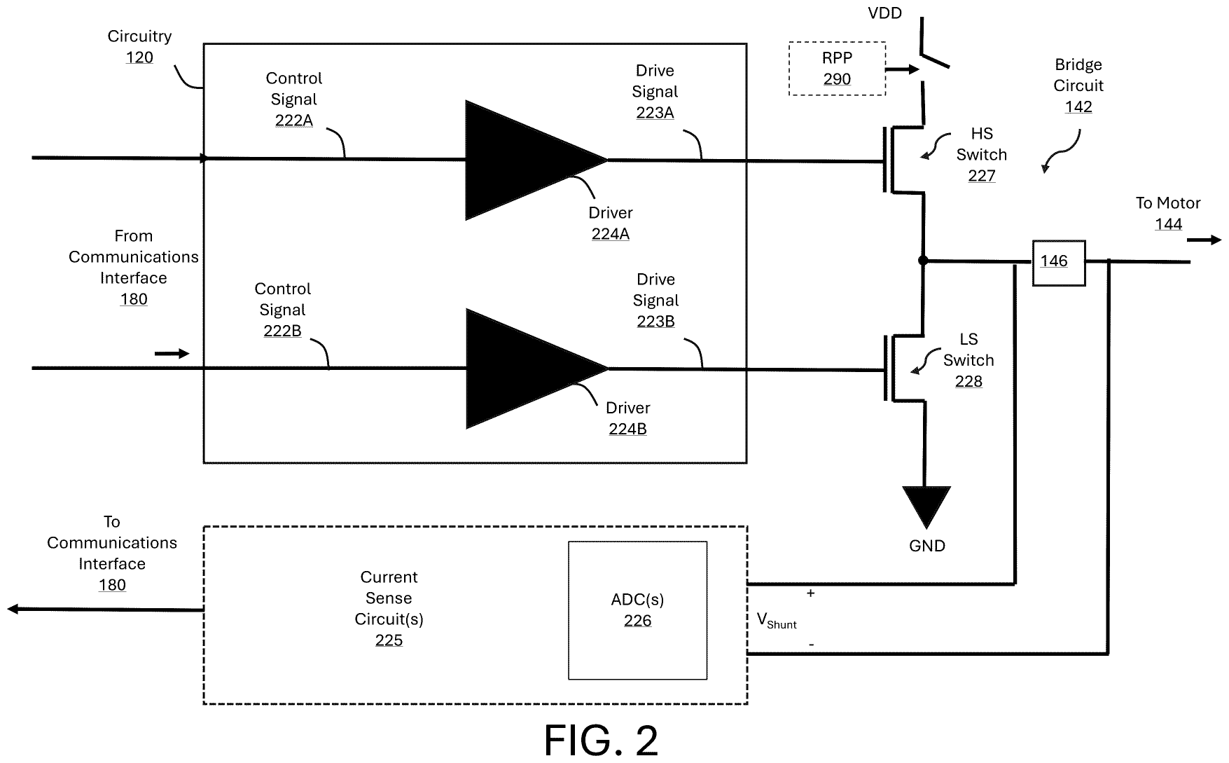

FIG. 2 is a block diagram that depicts one example of a driver circuitry 120 that may be integrated as part of integrated braking interface device 101 according to some embodiments. Referring back to the example of FIG. 1, driver circuitry 120 is configured to drive a bridge circuit 142. In the FIG. 2 example the driver circuitry 120 include a pair of drivers 224A, 224B coupled to the respective gate terminals of a high side power switch 227 and a low side power switch 228 (collectively “power switches 227, 228”) to supply energy to a load (e.g., to a phase of a three-phrase motor 144). The drivers 224A, 224B are configured to amplify an input control signals 222A, 222B to generate driver signals 223A, 223B with a strong current sufficient to turn on and turn of the respective power switches 227, 228 to efficiently transfer energy to the motor 144. In some examples, drivers 224A, 224B are configured operate with a control signal with a pulse width modulated (PWM) duty cycle that is variable between 0-100%. In some examples, the driver circuitry 120 may include more drivers configured to drive more power switches. For example, the driver circuitry 120 may include a pair of drivers 224A, 224B to drive a pair of power switches 227, 228 associated with each of three phases of a three-phase motor. In other examples, instead of a three-phase motor, the driver circuitry 120 is configured to control a motor with more or fewer phases. The motor may be a brushless DC motor, a brushed DC motor, or any other type of motor.

In some examples, the driver circuitry 120 is configured to drive the power switches 227, 228 of the bridge circuit as current sources with a predetermined number of finite amplitude steps with a defined resolution. For example, the driver circuitry 120 may be configured to drive the power switches 227, 228 with an output current having up to 128 steps and/or a resolution of around 13 nanoseconds. In some examples, the driver circuitry 120 may be configurable to drive the power switches 227, 228 in applications with different output voltage ranges, for example from zero to 5V, 8V, 12V, 15V, 18V, or any voltage range up to or exceeding 28 volts.

As shown in FIG. 2, in some examples, the integrated device 101 shown in FIG. 1 may optionally further include one or more current sense circuits 225 housed within the package 110 that are coupled to measure a current through the bridge circuit 142. For example, as shown in FIG. 2, the bridge circuit 142 may include one or more shunt(s) 146 with a known resistance coupled between the bridge circuit 142 and the motor 144 as shown in the FIG. 2 example. In other examples not depicted in FIG. 2, the shunt 146 may instead be coupled between the HS switch 227 and a positive power supply VDD, or between the LS switch 227 and a ground reference. The current sense circuit(s) 225 include one or more analog to digital converter (ADC) circuits 226, operational amplifiers with analog outputs coupled to the main controller 102, or other circuitry coupled to sample an voltage V_{Shunt} across the shunt(s) 146 to generate a digital representation of the current through the power switches 227, 228. As shown in FIG. 2, the current sense circuits 225 may output the measured current through the power switches 227, 228 via the communications interface 180 of the integrated device 101. In some non-limiting examples, the ADC circuit(s) 226 are sigma delta ADC circuits. In some non-limiting examples, the ADC circuit(s) are configured to operate over a 50 mV input range with a resolution of around 12 bits. In some non-limiting examples, the ADC circuit(s) 226 are configured to generate a digital message representing a measured current with 11 bits. In some examples, the ADC circuit(s) 226 or configurable to operate with two filter types between average measurement and instantaneous measurement of a current.

As also shown in FIG. 2, the integrated device 101 may optionally further include reverse polarity protection (RPP) circuitry 290 housed within the package 110. According to these examples, the RPP circuitry 290 is coupled through the package 110 to the bridge circuit 142 to protect the bridge circuit 142 from damage. The RPP circuitry 290 is configured to monitor a reverse polarity gate voltage of the power switches 227, 228 to perform over and under voltage supervision to detect when a reverse polarity supply (e.g., opposite terminals of a battery) is coupled to the bridge circuit 142, and disconnect the power switches 227, 228 of the bridge circuit 142 from the power supply to protect the power switches 227, 228 from damage. In some non-limiting examples, the RPP circuitry 290 includes an RPP I/O port on the package 110 driven by a charge pump with an output capacitor coupled to a Direct Current (DC) link voltage. Although not depicted in FIG. 2, in some examples the integrated device 101 further includes a diagnostics module configured to perform extended monitoring and diagnostic functions on the driver circuitry 120, including monitoring, fault detection, built in self-tests (BIST), functional self-tests, and error logic.

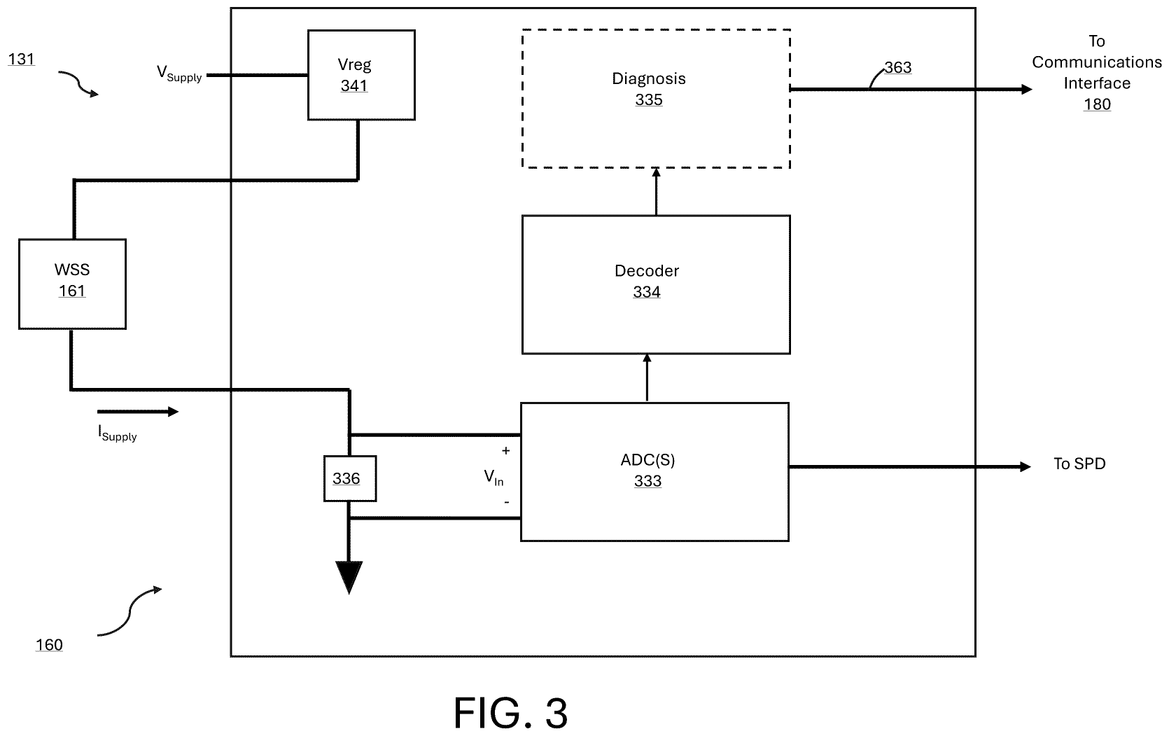

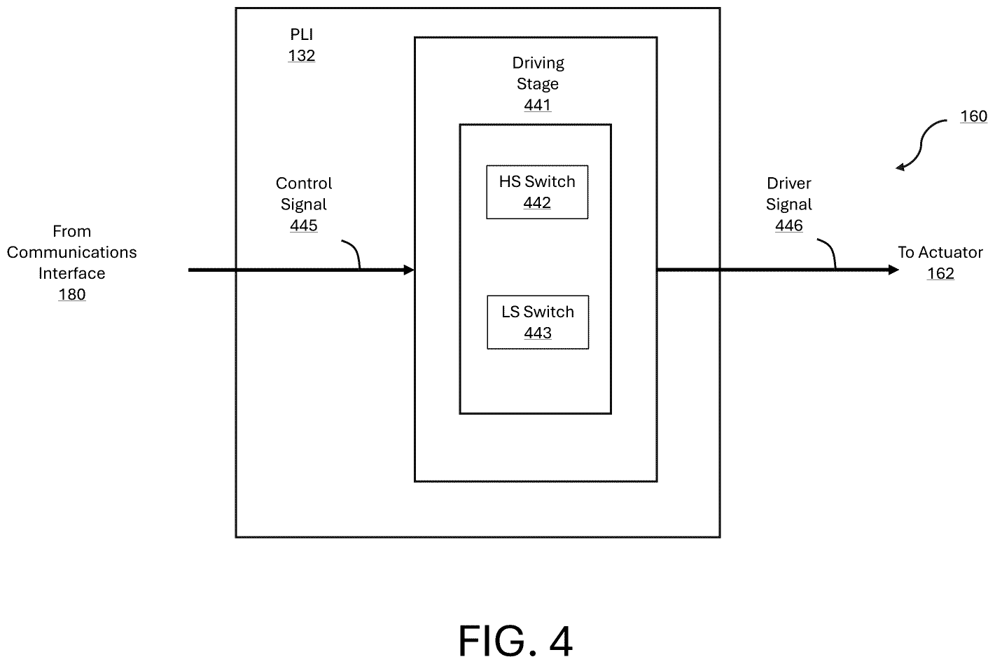

As shown in FIG. 1, the integrated device 101 houses the driver circuitry 120 depicted in FIG. 2 in package 110 along with one or more other braking system interface circuit(s) 130, which include a wheel speed sensor interface (WSSI) 131 and/or a parking brake interface (PLI) 132 of the vehicle. FIG. 3 depicts a WSSI 131 which may be integrated in package 110 with the driver circuitry 120 according to some embodiments. FIG. 4 depicts a PLI 132 which may be integrated in package 110 with the driver circuitry 120 according to some embodiments.

Referring now to FIG. 3, the WSSI 131 is configured to receive wheel speed data from at least one wheel speed sensor 161 of a vehicle. The WSSI 131 may be a sensor arranged proximal to a wheel of the vehicle and configured to track the rotational speed of the wheel. For example, the wheel speed sensor 161 may include a Giant Magnetoresistance (GMR) sensor, a Hall Effect sensor, or the like configured to generate a pulse each time the wheel speed sensor 161 sensor detects a rotation of the wheel.

The WSSI 131 is configured to generate a regulated power supply to the wheel speed sensor 161. The WSSI may generate the regulated supply limited to a maximum voltage to protect the wheel speed sensor 161, for example, by limiting the supply voltage to around 14 volts or 13 volts. As shown in FIG. 3, the WSSI 131 includes a voltage regulator 341 configured to receive an input supply voltage (e.g., from a battery), and output a regulated power supply suitable to power the wheel speed sensor 161. The voltage regulator 341 may be a low drop out (LDO) voltage regulator configured to generate the regulated supply voltage in some embodiments.

The WSSI 131 may be configured to communicate wheel speed sensor data via the regulated power supply. For example, the wheel speed sensor 161 may be configured to encode wheel speed data in a supply current I_{Supply} of the power supply to communicate wheel speed data to the WSSI 131. As one non-limiting example, the wheel speed data may be communicated by pulse(s) that indicate whether the wheel speed is fast or slow. The message may include a first pulse with one of two or three discrete current levels that indicate a high and low, or high, medium, or low speed. In some examples, the first pulse may be followed by a plurality of binary pulses that represent additional information.

As shown in FIG. 3, the WSSI 131 includes circuitry configured to decode wheel speed data from the wheel speed sensor 161 and output the received wheel speed data 363 to the communications interface 180 of integrated device 101. As shown in FIG. 3, the WSSI 131 includes a shunt 336 coupled to the wheel speed sensor 161 such that the supply current I_{Supply} of the wheel speed sensor 161 flows through the shunt 336. The WSSI 131 also includes one or more analog to digital conversion circuit(s) (ADC(s)) 333 (which may instead be other comparators or circuitry) configured to sample a voltage Vᵢₙ across the shunt 336 to output a digital values that represent the current I_{Supply} to a decoder 334. The decoder 334 is configured to decode the digital values from the ADC and prepare wheel speed data 363 for sending via communications interface 180, for example by performing Manchester decoding. The WSSI 131 may optionally include a diagnostics module 335 configured to perform sensor diagnostic, self-test routines and/or calibration processes. In addition, the WSSI 131 may be configured to output the digital values from the ADC circuit(s) 333 before they are decoded by the decoder 334. For example, the WSSI 131 may be coupled to one or more Speed (SPD) I/O port(s) of the integrated device 101 (not shown) that outputs a pulse each time wheel rotation is detected.

FIG. 4 depicts a PLI 132 which may be integrated in package 110 with the driver circuitry 120 according to some embodiments. The PLI 132 is configured to control an actuator 162 to lock a wheel of the vehicle, i.e., to inhibit the wheel from rotating to implement a parking lock function of the vehicle. For example, the PLI 132 may be configured to control an actuator to lock the braking mechanism 140 of the vehicle. In some examples, the actuator 162 is a solenoid coupled to the brake pad of the braking mechanism 140 that is controllable between a locked position in which the wheel is inhibited from rotating, and an unlocked position in which the wheel not inhibited if braking mechanism 140 is not otherwise engaged to inhibit rotation of the wheel (i.e., by driver circuitry 120). In other examples, the PLI 132 may be configured to control another motor or other type actuator configured to lock or release the wheel of the vehicle.

As depicted in FIG. 4, PLI 132 includes a driving stage 441 which includes a high side switch 442 and a low side switch 443. In some other examples, the driving stage 441 may instead include a low side switch 442 and a freewheeling diode instead of a high-side switch 442. The driving stage 441 is configured to receive a pulse width modulated (PWM) control signal 445 from the communications interface 180 of the integrated parking device 101 and control the high side and low side switches to control a current supplied to the actuator 162 as a drive signal 446. As a non-limiting example in which the actuator 162 is a solenoid, the main controller 102 may receive input that a parking brake lever has been engaged by a vehicle operator. In response, the main controller 102 may send a control signal 445 to cause the driving stage 441 to supply a drive signal 446 with a sufficient current for a sufficient time to drive the solenoid to lock the wheel. As another example, the main controller 102 may receive input that the parking brake lever has been disengaged, and send a control signal 445 to cause the driving stage 441 to supply a drive signal 446 with a sufficient current for a sufficient time to drive the solenoid to release the wheel. According other examples not depicted in FIG. 4, the actuator 162 may be an additional motor, and the driving stage 441 includes a H-bridge with two high side and two low side MOSFETS configured to drive the additional motor to lock or release the wheel based on input from a vehicle operator or other input.

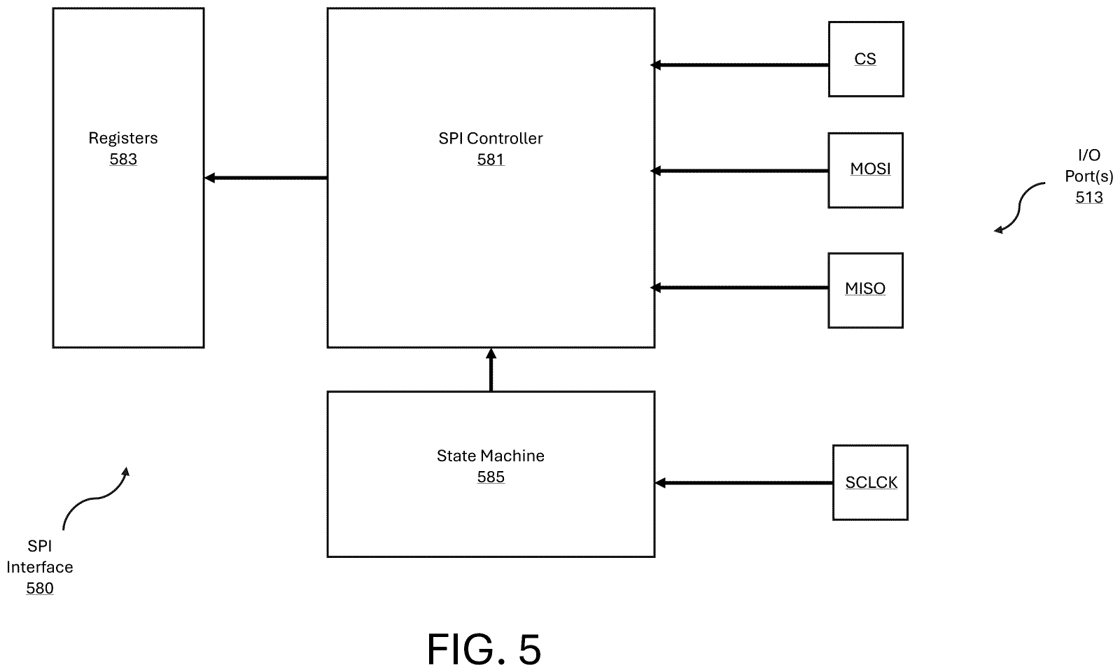

FIG. 5 is a block diagram depicting one example of a serial peripheral (SPI) interface 580 which may be housed within a package 110 of integrated device 101 depicted in FIG. 1 according to some embodiments. According to the example of FIG. 5, the SPI interface 580 includes an SPI controller 581, a state machine 585, and a plurality of registers 583. The SPI interface 580 is coupled to a plurality of I/O port(s) 513, including a chip select (CS) I/O port, a Master Out Slave In (MOSI) I/O port, a Master In Slave Out (MISO) I/O port, and an system clock (SCLOCK) I/O port. The SPI controller 581 is operative to communicate data serially to a recipient node defined by the CS signal by reading and writing MOSI and MISO bits to registers 583 defined by the state machine 585, which operates based on the system clock SCLCK from the main controller 102.

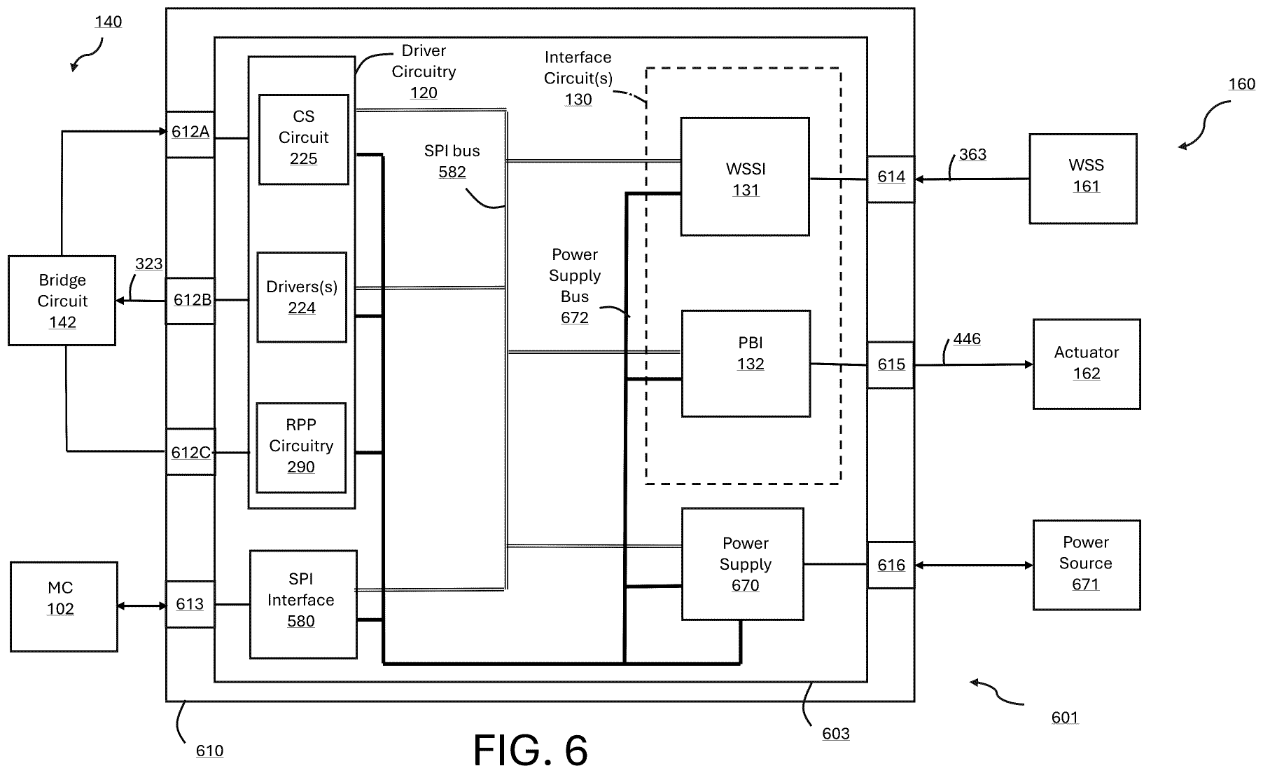

FIG. 6 is a block diagram that depicts an integrated braking interface device 601 that includes driver circuitry 120 housed within a package 610 along with one or more braking system interface circuits 130 according to some embodiments. According to the example of FIG. 6, the integrated device 601 includes a WSSI 131 coupled through one or more I/O ports 614 to supply power to and/or receive wheel speed sensor wheel speed sensor data from a wheel speed sensor 161 of a vehicle. The integrated device 601 also includes a PLI 132 coupled to one or more I/O ports 615 to engage or release an actuator 162, which may be a solenoid in some examples, with a control signal 164. In other examples not depicted, the integrated device 601 may not include both the WSSI 131 and the PLI 132, and instead include only one of the WSSI 131 or the PLI 132 integrated with the driver circuitry 120.

As shown in the FIG. 6 example, integrated device 601 includes driver circuitry 120 coupled through a plurality of I/O ports 612A-612C to the bridge circuit 142. As shown in FIG. 6, the driver circuitry includes one or more driver(s) 224 coupled through I/O port(s) 612B to respective gates of power switches of the bridge circuit 142, to control the bridge circuit 142 to drive the motor 144 of the braking mechanism 140 based on control signals 323 from the main controller 102. In addition, the driver circuitry 120 includes one or more current sense circuits 225 coupled thorough one or more I/O port(s) 612A and configured to sense a current associated with the bridge circuit 142, such as a current through one or more respective high and low side transistor pairs of the bridge circuit configured to supply energy to a phase of the motor 144, and send the measured current to the main controller 102 for use as feedback by the main controller 102. In addition, the driver circuitry 120 includes reverse polarity protection circuitry 290 coupled through one or more I/O ports 612C to disconnect a power supply of the bridge circuit 142 to protect power switches of the bridge circuit 142 from damage if a power source is connected to the bridge circuit 142 with reversed polarity.

In the example of FIG. 6, the integrated device 601 further includes a Serial Peripheral (SPI) interface 580 mounted on the PCB 603 housed within the package 610 and an SPI bus 582 also housed within the package 610 that couples the SPI interface 580 to the driver circuitry 120, the WSSI 131, and/or the PLI 132. The SPI interface 580 is coupled to communicate with a main controller 102 external to the package 610 via one or more I/O port(s) 613.

The SPI interface 580 and the SPI bus 582 are configured to enable the respective internal driver circuitry, WSSI 131, and/or PLI 132 housed within the package 610 to communicate with other components external to package 610, such as main controller 102. For example, the main controller 102 may use the SPI interface 580 to communicate control signal(s) to the driver circuitry 120 to control the bridge circuit 142, and at the same time receive current sense signals from the bridge circuit 142 via the same SPI interface 580. The main controller 102 may also receives wheel speed data 363 from the WSSI 131 through the SPI interface 580, and use the received wheel speed data 363 as feedback to generate the control signal(s) to the control the bridge circuit 142. In addition, the main controller 102 may use the SPI interface 580 to send control signals to the PLI 132 to generate a drive signal 446 to engage or disengage the actuator 162 to lock the braking mechanism 140.

In the example of FIG. 6, the integrated device 601 further includes a power supply module 670 integrated in the package with the driver circuitry 120, the WSSI 131 and/or the PLI 132. The power supply module 670 is coupled through one or more I/O port(s) 616 to a power source 671 such as a battery. The power supply module 670 is coupled via a power supply bus 672 to supply power to the respective components of integrated device 601, including driver circuitry 120, WSSI 131, PLI 132, and SPI interface 580. In the FIG. 5 example, the same power bus 672 is used to supply the driver circuitry 120, the WSSI 131, and the PLI 132, as well as the SPI interface 580. In other examples not depicted, the power supply module 670 is configured to supply multiple power bus 672 to provide different supplies at different voltage levels to at least some of components of integrated device, including driver circuitry 120, WSSI 131, PLI 132, and/or SPI interface 580. Although not depicted in FIG. 6, in some examples the integrated device 601 further includes an independent “Safe Off” I/O port configured to switch off the power switches of the bridge circuit 142 to protect them from damage, even if other parts of the driver circuitry 120 are damaged.

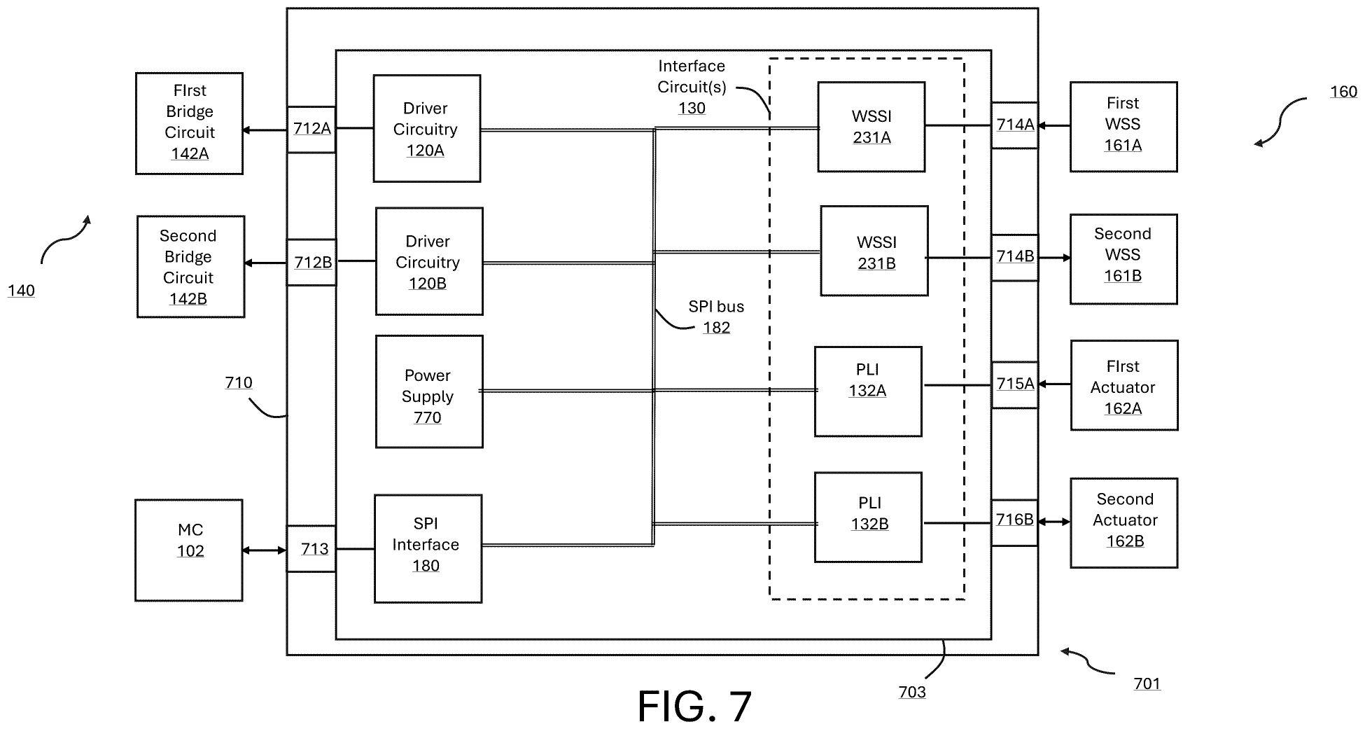

FIG. 7 is a block diagram that depicts an integrated braking interface device 701 configured to serve as an interface for braking systems associated more than one wheel of a vehicle according to some embodiments. The integrated device 701 depicted in FIG. 6 differs from integrated device 601 in that it is configured to serve as an interface for braking system components associated with two wheels of a vehicle in the same package 710. In the example of FIG. 7, the integrated device 701 includes first driver circuitry 120A mounted on a PCB 703 and coupled through one or more I/O ports 712A to control a first bridge circuit 142A to drive a motor associated with a first wheel of a vehicle, and second driver circuitry 120B mounted on the PCB 703 coupled through one or more I/O ports 712B to control a second bridge circuit 142A to drive a second motor associated with a second wheel of the vehicle.

The integrated device 701 further includes a first WSS interface 231A mounted on the PCB 703 and coupled through one or more I/O port(s) 714A to a wheel speed sensor 161A associated with a first wheel of the vehicle, and a second WSS interface 231B mounted on the PCB 703 and coupled through one or more I/O port(s) 714B to a wheel speed sensor 161B associated with a second wheel of the vehicle. The integrated device 701 further includes a first PLI 132A mounted on the PCB 703 and coupled through one or more I/O port(s) 715A to control an actuator 162A to lock the first wheel of the vehicle, and a second PLI 132B mounted on the PCB 703 and coupled through one or more I/O port(s) 716B to control an actuator 162B to lock the second wheel of the vehicle. The integrated device 701 further includes a SPI interface 580 mounted on the PCB 703 and configured to communicatively couple the respective driver circuitry 120A-120B, WSSI 231A-231B and/or PLI 132A-132B external to the package 610 through the I/O port(s) 713, for example to receive commands from and/or to send data to a main controller 102. The integrated device 701 of FIG. 7 further includes a power supply module 770 mounted on the PCB 703 and coupled to supply suitable power supply to the respective driver circuitry 120A-120B, WSSI 231A-231B, PLI 132A-132B, and/or SPI interface(s) 580.

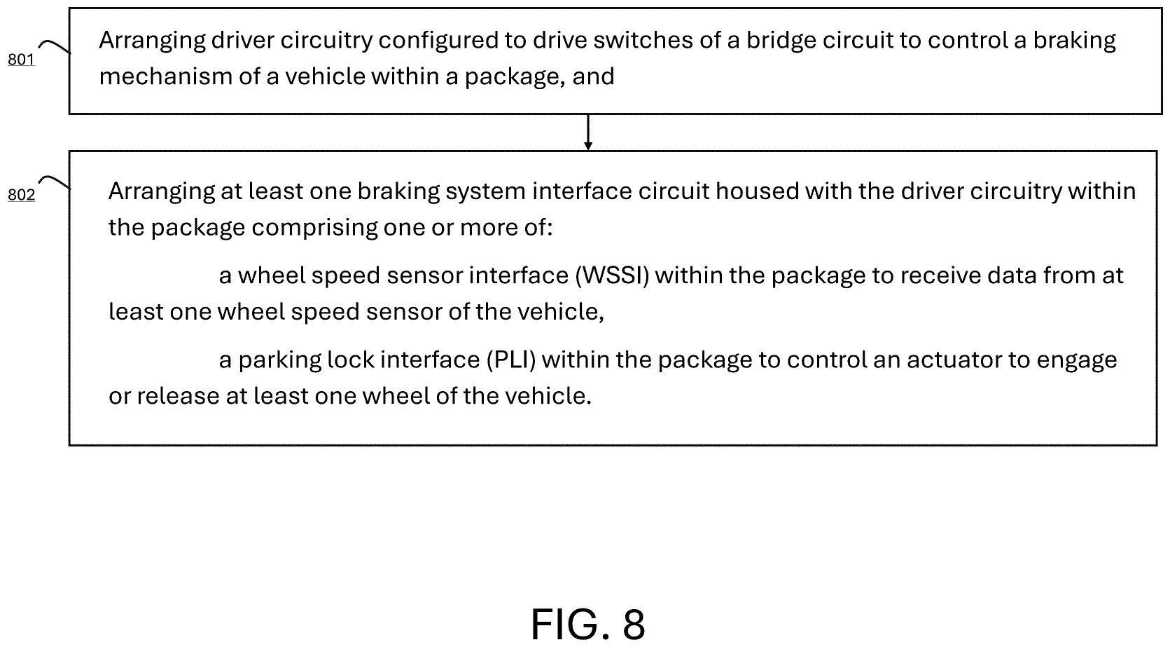

FIG. 8 is a flow diagram that depicts a method according to some embodiments. As shown in FIG. 8, at 801, the method includes arranging driver circuitry 120 configured to drive switches of a bridge circuit 142 to control a braking mechanism 140 of a vehicle within a package 110. As shown in FIG. 8, at 802, the method includes arranging at least one braking system interface circuit 130 with the driver circuitry 120 within the package 110. The braking system interface circuit includes one or more of a wheel speed sensor interface (WSSI) 131 to receive wheel speed data from at least one wheel speed sensor 161 of the vehicle and a parking lock interface (PLI) 132 to control an actuator 162 to lock a wheel of the vehicle. The actuator may be a solenoid, another motor, or other type of actuator configured to lock the wheel of the vehicle.

In some examples, the method further includes coupling a first I/O port 112 of the package to the driver circuitry. In some examples, the method further includes coupling a second I/O port 114 of the package to the WSSI. In some examples, the method further includes coupling a third I/O port 115 of the package to the PLI. In some examples, the method further includes coupling the WSSI through the package to send the wheel speed data to a main controller 102 external to the package, and coupling the PLI through the package to receive a control signal from the main controller to control the actuator.

In some examples, the method further includes arranging a serial peripheral (SPI) interface 580 within the package to communicate external to the package. In some examples, the method further includes coupling the driver circuitry and at least one interface circuit to communicate external to the package using the SPI circuit. In some examples, the method further includes arranging analog to digital conversion circuitry 235 within the package configured to convert a measured current signal of WSSI from analog to digital. In some examples, the method further includes arranging reverse polarity protection (RPP) circuitry 290 within the package configured to convert a measured current signal of the wheel speed sensor from analog to digital.

In some examples, the driver circuitry is first driver circuitry 120A within the package 710 to control switches of a first bridge circuit 142A associated with a first wheel of the vehicle, and the method further includes arranging second driver circuitry 120B within the package to control switches of a second bridge circuit 142B associated with a second wheel of the vehicle. In some examples, the WSSI is a first WSSI 131A associated with the first wheel of the vehicle, and the method further includes arranging a second WSSI 131B associated with the second wheel of the vehicle within the package. In some examples, the PLI is a first PLI 132A associated with the first wheel of the vehicle, and the method further includes arranging a second PLI 132B associated with the second wheel of the vehicle within the package.

### Clauses

Clause 1. An integrated device, comprising: a package; driver circuitry housed within the package to drive switches of a bridge circuit to control a braking mechanism of a vehicle; and at least one braking system interface circuit housed with the driver circuitry within the package comprising one or more of: a wheel speed sensor interface (WSSI) to receive wheel speed data from at least one wheel speed sensor of the vehicle; and a parking lock interface (PLI) to control an actuator to lock at least one wheel of the vehicle.

Clause 2. The integrated device of clause 1, wherein the package comprises one or more of: a first I/O port configured to couple the driver circuitry to drive switches of the bridge circuit; a second I/O port configured to couple the WSSI to the at least one wheel speed sensor; and a third I/O port configured to couple the PLI to the actuator.

Clause 3. The integrated device of any of clauses 1 and 2, wherein the driver circuitry is coupled through the package to drive the switches of the bridge circuit, the WSSI is coupled through the package to send the wheels speed data to a microcontroller external to the package, and the PLI is coupled through the package to receive a control signal from the microcontroller to control the actuator.

Clause 4. The integrated device of any of clauses 1-3, further comprising: a serial peripheral interface (SPI) circuit housed within the package to communicate external to the package.

Clause 5. The integrated device of clause 4, wherein the driver circuitry and the at least one braking system interface circuit are configured to communicate external to the package using the SPI circuit.

Clause 6. The integrated device of any of clauses 1-5, further comprising: reverse polarity protection (RPP) circuitry housed within the package and configured protect the bridge circuit.

Clause 7. The integrated device of any of clauses 1-6, wherein the driver circuitry is first driver circuitry housed within the package to control switches of a first bridge circuit associated with a first wheel of a vehicle, and wherein the integrated device further comprises: second driver circuitry housed within the package to control switches of a second bridge circuit associated with a second wheel of the vehicle.

Clause 8. The integrated device of clause 7, wherein the WSSI is a first WSSI associated with the first wheel of the vehicle, and wherein the integrated device further comprises: a second WSSI housed within the package associated with the second wheel of the vehicle.

Clause 9. The integrated device of any of clauses 7-8, wherein the PLI is a first PLI associated with the first wheel of the vehicle, and further comprising: a second PLI housed within the package associated with the second wheel of the vehicle.

Clause 10. A method, comprising: arranging driver circuitry configured to drive switches of a bridge circuit to control a braking mechanism of a vehicle within a package; and arranging at least one braking system interface circuit with the driver circuitry within the package comprising one or more of: a wheel speed sensor interface (WSSI) to receive wheel speed data from at least one wheel speed sensor of the vehicle; and a parking lock interface (PLI) to control an actuator to lock at least one wheel of the vehicle.

Clause 11. The method of any of clause, further comprising: coupling a first I/O port of the package to the driver circuitry; coupling a second I/O port of the package to the WSSI; and coupling a third I/O port of the package to the PLI.

Clause 12. The method of any of clauses 10-11, further comprising: coupling the WSSI through the package to send the wheel speed data to a microcontroller external to the package, and coupling the PLI through the package to receive a control signal from the microcontroller to control the actuator.

Clause 13. The method of any of clauses 10-12, further comprising: arranging a serial peripheral interface (SPI) circuit within the package to communicate external to the package.

Clause 14. The method of clause 13, further comprising: coupling the driver circuitry and the at least one interface circuit to communicate external to the package using the SPI circuit.

Clause 15. The method of any of clauses 10-14, further comprising: arranging reverse polarity protection (RPP) circuitry housed within the package and configured protect the bridge circuit.

Clause 16. The method of any of clauses 10-15, wherein the driver circuitry comprises first driver circuitry within the package, and further comprising: arranging second driver circuitry within the package to control switches of a second bridge circuit associated with a second wheel of the vehicle.

Clause 17. The method of clause 16, wherein the WSSI comprises a first WSSI associated with the first wheel of the vehicle, and further comprising: arranging a second WSSI associated with the second wheel of the vehicle within the package.

Clause 18. The method of any of clauses 16-17, wherein the PLI is a first PLI associated with the first wheel of the vehicle, and further comprising: arranging a second PLI associated with the second wheel of the vehicle within the package.

Clause 19. A system, comprising: a main controller housed in a first package; driver circuitry housed in a second package, wherein the main controller is configured to control the driver circuitry to drive switches of a bridge circuit to control a braking mechanism of a vehicle; and at least one braking system interface circuit housed with the driver circuitry within the second package comprising one or more of: a wheel speed sensor interface (WSSI) to receive wheel speed data from at least one wheel speed sensor of the vehicle and output the wheel speed data to the main controller; and a parking lock interface (PLI) configured to be controlled by the main controller to control an actuator to lock at least one wheel of the vehicle.

Clause 20. The system of clause 19, wherein the second package comprises one or more of: a first I/O port configured to couple the driver circuitry to drive switches of the bridge circuit; a second I/O port configured to couple the WSSI to the at least one wheel speed sensor; and a third I/O port configured to couple the PLI to the actuator.

Clause 21. The system of any of clauses 19-20, further comprising: a serial peripheral interface (SPI) circuit housed within the second package to communicate external to the package.

Clause 22. The system of clause 21, wherein the driver circuitry and the at least one interface circuit are configured to communicate external to the second package using the SPI circuit.

Clause 23. The system of any of clauses 19-22, wherein the at least one interface circuit further comprises: reverse polarity protection (RPP) circuitry housed within the package and configured protect the bridge circuit.

Clause 24. The system of any of clauses 19-23, wherein the driver circuitry comprises first driver associated with a first wheel of the vehicle, and further comprising: second driver circuitry housed within the second package to control switches of a second bridge circuit associated with a second wheel of the vehicle.

Clause 25. The system of clause 24, wherein the WSSI is a first WSSI associated with the first wheel of the vehicle, and further comprising: a second WSSI associated with the second wheel of the vehicle.

Clause 26. The system of any of clauses 24-25, wherein the PLI is a first PLI associated with the first wheel of the vehicle, and further comprising: second PLI associated with the second wheel of the vehicle.

Clause 27. The system of any of clauses 19-26, wherein the main controller is a microcontroller, and further comprising: a Power Management Integrated Circuit (PMIC) housed in the first package with the main controller.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. An integrated device, comprising:
a package;
driver circuitry housed within the package to drive switches of a bridge circuit to control a braking mechanism of a vehicle; and
at least one braking system interface circuit housed with the driver circuitry within the package comprising one or more of:
a wheel speed sensor interface (WSSI) to receive wheel speed data from at least one wheel speed sensor of the vehicle; and
a parking lock interface (PLI) to control an actuator to lock at least one wheel of the vehicle.

2. The integrated device of claim 1, wherein the package comprises one or more of:
a first I/O port configured to couple the driver circuitry to drive switches of the bridge circuit;
a second I/O port configured to couple the WSSI to the at least one wheel speed sensor; and
a third I/O port configured to couple the PLI to the actuator.

3. The integrated device of claim 1, wherein the driver circuitry is coupled through the package to drive the switches of the bridge circuit, the WSSI is coupled through the package to send the wheels speed data to a microcontroller external to the package, and the PLI is coupled through the package to receive a control signal from the microcontroller to control the actuator.

4. The integrated device of claim 1, further comprising:
a serial peripheral interface (SPI) circuit housed within the package to communicate external to the package.

5. The integrated device of claim 4, wherein the driver circuitry and the at least one braking system interface circuit are configured to communicate external to the package using the SPI circuit.

6. The integrated device of claim 1, further comprising:
reverse polarity protection (RPP) circuitry housed within the package and configured protect the bridge circuit.

7. The integrated device of claim 1, wherein the driver circuitry is first driver circuitry housed within the package to control switches of a first bridge circuit associated with a first wheel of a vehicle, and wherein the integrated device further comprises:
second driver circuitry housed within the package to control switches of a second bridge circuit associated with a second wheel of the vehicle.

8. The integrated device of claim 7, wherein the WSSI is a first WSSI associated with the first wheel of the vehicle, and wherein the integrated device further comprises:
a second WSSI housed within the package associated with the second wheel of the vehicle.

9. The integrated device of claim 8, wherein the PLI is a first PLI associated with the first wheel of the vehicle, and further comprising:
a second PLI housed within the package associated with the second wheel of the vehicle.

10. A method, comprising:
arranging driver circuitry configured to drive switches of a bridge circuit to control a braking mechanism of a vehicle within a package; and
arranging at least one braking system interface circuit with the driver circuitry within the package comprising one or more of:
a wheel speed sensor interface (WSSI) to receive wheel speed data from at least one wheel speed sensor of the vehicle; and
a parking lock interface (PLI) to control an actuator to lock at least one wheel of the vehicle.

11. The method of claim 10, further comprising:
coupling a first I/O port of the package to the driver circuitry;
coupling a second I/O port of the package to the WSSI; and
coupling a third I/O port of the package to the PLI.

12. The method of claim 10, further comprising:
coupling the WSSI through the package to send the wheel speed data to a microcontroller external to the package, and coupling the PLI through the package to receive a control signal from the microcontroller to control the actuator.

13. The method of claim 10, further comprising:
arranging a serial peripheral interface (SPI) circuit within the package to communicate external to the package.

14. The method of claim 13, further comprising:
coupling the driver circuitry and the at least one interface circuit to communicate external to the package using the SPI circuit.

15. The method of claim 10, further comprising:
arranging reverse polarity protection (RPP) circuitry housed within the package and configured protect the bridge circuit.

16. The method of claim 10, wherein the driver circuitry comprises first driver circuitry within the package, and further comprising:
arranging second driver circuitry within the package to control switches of a second bridge circuit associated with a second wheel of the vehicle.

17. The method of claim 16, wherein the WSSI comprises a first WSSI associated with the first wheel of the vehicle, and further comprising:
arranging a second WSSI associated with the second wheel of the vehicle within the package.

18. The method of claim 17, wherein the PLI is a first PLI associated with the first wheel of the vehicle, and further comprising:
arranging a second PLI associated with the second wheel of the vehicle within the package.

19. A system, comprising:
a main controller housed in a first package;
driver circuitry housed in a second package, wherein the main controller is configured to control the driver circuitry to drive switches of a bridge circuit to control a braking mechanism of a vehicle; and
at least one braking system interface circuit housed with the driver circuitry within the second package comprising one or more of:
a wheel speed sensor interface (WSSI) to receive wheel speed data from at least one wheel speed sensor of the vehicle and output the wheel speed data to the main controller; and
a parking lock interface (PLI) configured to be controlled by the main controller to control an actuator to lock at least one wheel of the vehicle.

20. The system of claim 19, wherein the second package comprises one or more of:
a first I/O port configured to couple the driver circuitry to drive switches of the bridge circuit;
a second I/O port configured to couple the WSSI to the at least one wheel speed sensor; and
a third I/O port configured to couple the PLI to the actuator.

21. The system of claim 19, further comprising:
a serial peripheral interface (SPI) circuit housed within the second package to communicate external to the package.

22. The system of claim 21, wherein the driver circuitry and the at least one interface circuit are configured to communicate external to the second package using the SPI circuit.

23. The system of claim 19, wherein the at least one interface circuit further comprises:
reverse polarity protection (RPP) circuitry housed within the package and configured protect the bridge circuit.

24. The system of claim 19, wherein the driver circuitry comprises first driver associated with a first wheel of the vehicle, and further comprising:
second driver circuitry housed within the second package to control switches of a second bridge circuit associated with a second wheel of the vehicle.

25. The system of claim 24, wherein the WSSI is a first WSSI associated with the first wheel of the vehicle, and further comprising:
a second WSSI associated with the second wheel of the vehicle.

26. The system of claim 25, wherein the PLI is a first PLI associated with the first wheel of the vehicle, and further comprising:
second PLI associated with the second wheel of the vehicle.

27. The system of claim 19, wherein the main controller is a microcontroller, and further comprising:
a Power Management Integrated Circuit (PMIC) housed in the first package with the main controller.
